(19) United States
(12) Patent Application Publication
(10) Pub. No.: US 2007/0294025 A1
(43) Pub. Date: Dec. 20, 2007

(54) Vehicle navigation system

(75) Inventor: Tatsuya Shintai, Chita-gun (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/810,934

(22) Filed: Jun. 7, 2007

(30) Foreign Application Priority Data
Jun. 20, 2006 (JP) 2006-170085

(51) Int. Cl. B60T 8/32; G01C 21/00

(52) U.S. Cl. 701/200; 701/93

(57) ABSTRACT

A vehicle navigation system is configured to connect a communication line from a wireless communication unit to a service center when a vehicle is traveling at a speed slower than a predetermined value and the communication line to the service center is not connected. By setting the predetermined value of the speed to a certain range in which the vehicle is highly probable to stop (e.g., a speed of a few kilometers per hour), the communication unit of the vehicle navigation system starts a connection operation of the communication line to the service center before the vehicle comes to a full stop, thereby enabling an establishment of connection of the communication line between the communication unit and the service center prior to the full stop of the vehicle.

### CROSS REFERENCE TO RELATED APPLICATION

This application is based on and claims the benefit of priority of Japanese Patent Application No. 2006-170085 filed on Jun. 20, 2006, the disclosure of which is incorporated herein by reference.

### FIELD OF THE INVENTION

The present invention generally relates to a navigation system and apparatus for use in a vehicle.

### BACKGROUND INFORMATION

In recent years, a vehicle navigation system having a data communication function exchanges data through a communication unit with a service center for sending and receiving various information. For example, Japanese patent document JP-A-2004-219231 discloses the vehicle navigation system having such function (This document is also published in US patent document 2006/0167935).

The vehicle navigation system is configured to not accept user operation while the vehicle is traveling, and is configured to accept user operation while the vehicle is stopping. Therefore, a user can input destination information and/or search information while the vehicle is stopping due to a traffic light, a traffic congestion or the like.

When the vehicle navigation system uses a communication service with a data communication capability, the vehicle navigation system exchanges data through a communication line established between the communication unit and the service center (e.g., a server). In this kind of communication service, the communication line is being connected for a predetermined period after the data communication is performed, and the communication line is disconnected after a certain period of no data communication time.

Therefore, when, for example, the user operates the navigation system to have an access to the service center while the vehicle is stopping, the access to the service center is promptly granted on a condition that the communication line has already been connected to the service center for exchange required information. However, when the communication line is not being connected to the service center (i.e., being in a disconnection condition) at the time of an access operation, the access to the service center is granted only after the establishment of the communication line by the communication unit. In this case, the vehicle may possibly start traveling while the communication unit is performing a communication line establishment procedure, thereby making it impossible for the user to operate the navigation system because the vehicle navigation system does not accept the user operation while the vehicle is traveling. Thus, the user of the conventional vehicle navigation system encounters inconvenience and suffers from frustration that he/she cannot exchange the required information with the service center.

### SUMMARY OF THE INVENTION

In view of the above and other problems, the present invention provides a vehicle navigation system and apparatus that has an improved usability by enabling a user to exchange data with a service center while a vehicle is stopping.

The vehicle navigation apparatus for use in a vehicle includes an operation unit that accepts a user operation by a user, a control unit that controls data communication between the communication unit and the service center, a wireless communication unit that wirelessly exchanges data with a service center through a communication line, and a speed sensor that detects a speed of the vehicle.

The operation of the vehicle navigation system is configured in the following manner. That is, when the user operation from the user on the operation unit is accepted only on a condition that the vehicle is in a stopping condition and the user operation is accompanied by the data communication between the wireless communication unit and the service center through the communication line, the data communication according to the user operation is either performed at a time of the user operation under a circumstance that the communication line is in a connected condition between the wireless communication unit and the service center, or performed at a time after connecting the communication line between the wireless communication unit and the service center under a circumstance that the communication line is disconnected between the wireless communication unit and the service center. Further, the control unit connects the communication line between the wireless communication unit and the service center when a first condition and a second condition are fulfilled, that is, the first condition is that the speed of the vehicle detected by the speed sensor is smaller than a predetermined value, and the second condition is that the communication line between the wireless communication unit and the service center is being disconnected.

According to the above configuration, the communication unit of the vehicle navigation system starts a connection operation of the communication line to the service center before the vehicle comes to a full stop by setting the predetermined value of the speed to a certain range in which the vehicle is highly probable to stop (e.g., a speed of a few kilometers per hour), thereby enabling an establishment of connection of the communication line between the communication unit and the service center prior to the full stop of the vehicle. That is, the usability of the vehicle navigation system is improved by having the communication line established between the communication unit and the service center for data exchange before the vehicle comes to the full stop.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a vehicular navigation system in an embodiment of the present disclosure; and

FIG. 2 shows a flowchart of a control process of the navigation system.

### DETAILED DESCRIPTION

Embodiments of the present invention are described with reference to the accompanying the drawings.

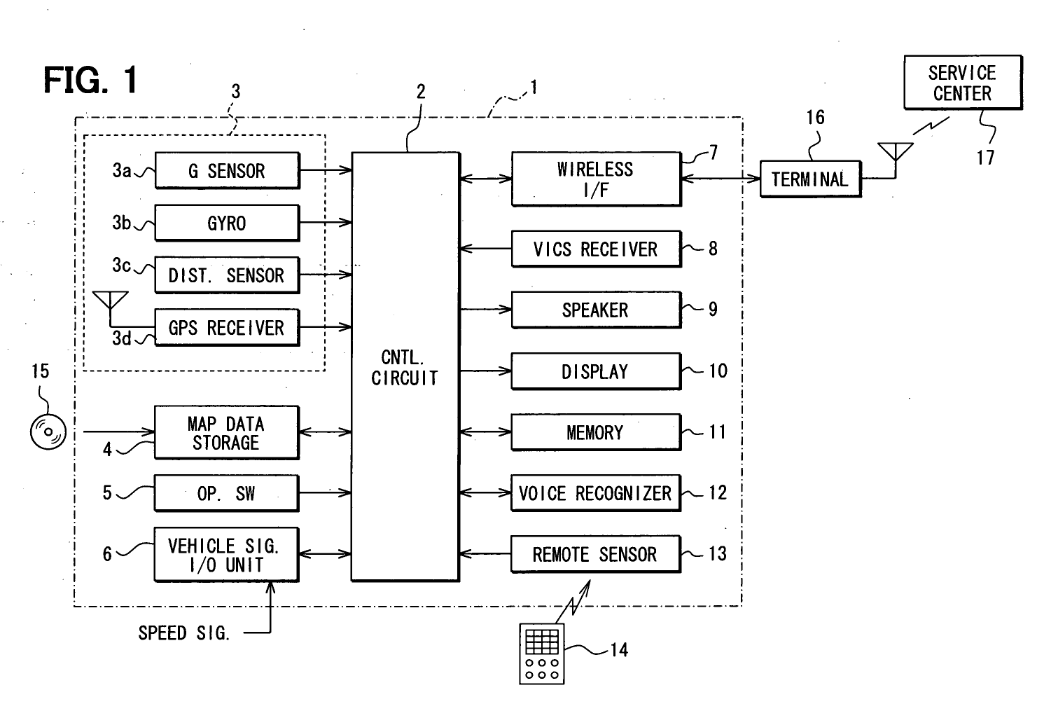

FIG. 1 shows a block diagram of a vehicular navigation system 1 in an embodiment of the present disclosure. The navigation system 1 includes a control circuit 2, a position detector 3, a map data storage 4, operation switches 5, a vehicle signal I/O unit 6, a wireless interface unit 7, a VICS receiver 8, a speaker 9, a display 10, a memory 11, a voice recognizer 12, a remote controller sensor 13, and a remote controller 14.

The control circuit 2 includes a CPU, a ROM, a RAM, an I/O interface and a bus for connecting the CPU with other components (not shown in the figure), and controls overall operations of the navigation system 1. The position detector 3 includes a G sensor 3a, a gyroscope 3b, a distance sensor 3c and a GPS receiver 3d. These components in the position detector 3 have detection errors of respectively different natures. Therefore, the control circuit 2 calculates a current position of a subject vehicle and other attributes such as a traveling direction, a vehicle speed, a travel distance and the like by correcting those errors of detection signals from respective components in a mutually compensating manner. In this case, the position detector 3 may not have all of the above components as long as it yields required detection accuracy of the current vehicle position, and may includes additional components such as a steering wheel rotation sensor and/or a tire rotation sensor on each of plural tires.

The map data storage 4 stores map data transferred from other memory media 15 such as a DVD-ROM or the like. In this case, the memory media 15 may be a hard disk driver (HDD), a memory card or the like. The operation switches 5 is mechanical switches disposed around the display 10, touch switches disposed on a color crystal display of the display 10 or the like. The vehicle signal I/O unit 6 is an interface to exchange various signals with various electronic control units (ECUs) and sensors. One of the signals comes from a vehicle speed sensor to input a vehicle speed signal (a vehicle speed pulse). The wireless interface unit 7 has an interface function that interfaces with a communication terminal 16. The control circuit 2 controls connection and disconnection of a communication line between the communication terminal 16 and a service center (i.e., a server) 17 through the wireless interface unit 7. The VICS receiver 8 receives VICS information from an external information source when it is available in Japan.

The speaker 9 outputs a voice message such as a route navigation from the current position toward the destination of the travel or the like. The display 10 is, for example, composed by using a color liquid crystal display unit or the like, and displays a map that represents the map data with a current position mark of the subject vehicle. The display 10 also displays a trace of travel of the subject vehicle on the map. The display 10 may be composed by using an organic electro-luminescence display, a plasma display unit or the like.

The memory 11 is composed by using a detachable flash memory card or the like. The voice recognizer 12 analyzes a user's voice captured by a microphone based on a voice recognition algorithm. The remote controller sensor 13 outputs to the control circuit 2 operation signals that are transmitted from the remote controller 14 by a radio wave.

The control circuit 2 in the above-described construction does not accept user inputs such as a user operation on the operation switches 5 and/or the remote controller 14 when the subject vehicle is traveling. On the other hand, the control circuit 2 accepts the user inputs when the subject vehicle is stopping.

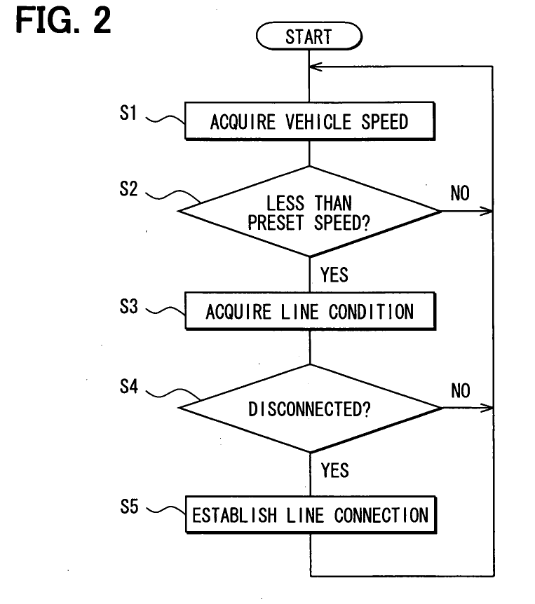

FIG. 2 shows a flowchart of a control process of the navigation system in the present embodiment. In the embodiment, the navigation system is configured to operate in the following manner. That is, the communication terminal 16 and the service center 17 are connected by the communication line for a predetermined period after performing the data communication, and the communication line is disconnected when the data communication has not been performed for the predetermined period.

When the control circuit 2 has an input from the speed signal from the speed sensor through the vehicle signal I/O unit, the speed signal is analyzed for determining the vehicle speed in step S1. The vehicle speed analyzed in step S1 is determined whether it is less than a predetermined speed in step S2. The predetermined speed of a few kilometers per hour in this case is used as a determination criterion whether it is probable for the vehicle to stop. The predetermined speed may be set by a manufacturer of the navigation system 1, or may be arbitrarily set by the user through the operation of the operation switches 5 and/or the operation remote controller 14.

Then, the control circuit 2 acquires a condition of the communication line between the terminal 16 and the center 17 from the wireless I/F unit 7 in step S3 when the vehicle speed is less than the predetermined speed (sep S2:YES), and determines whether the communication line is disconnected at the moment in step S4. The control circuit 2 establishes (or re-establishes) the connection of the communication line between the terminal 16 and the center 17 in step S5 when the communication line is determined to be disconnected in step S4 (step S4:YES).

In this manner, the navigation system 1 starts the connection operation of the communication line between the terminal 16 and the service center 17 when the communication line is determined to be disconnected at the vehicle speed under the predetermined value. Therefore, the communication line has already been connected to the service center 17 when the vehicle comes to the full stop, thereby enabling the user to have access to the service center 17 to exchange data for the improved usability.

Although the present invention has been fully described in connection with the preferred embodiment thereof with reference to the accompanying drawings, it is to be noted that various changes and modifications will become apparent to those skilled in the art.

For example, the function of the terminal 16 may be integrated in the navigation system 1.

Further, a brake signal in combination with the vehicle speed smaller than a predetermined value may be utilized as a trigger for determining whether the communication line between the terminal 16 and the center 17 is in a condition of disconnection.

Such changes and modifications are to be understood as being within the scope of the present invention as defined by the appended claims.

What is claimed is:

1. A vehicle navigation apparatus for use in a vehicle comprising:
an operation unit that accepts a user operation by a user;
a control unit that controls data communication;
a wireless communication unit that wirelessly exchanges data with a service center through a communication line, wherein, when the user operation from the user on the operation unit is accepted only on a condition that the vehicle is in a stopping condition and the user operation is accompanied by the data communication between the wireless communication unit and the service center through the communication line, the data communication according to the user operation is either performed at a time of the user operation under a circumstance that the communication line is in a connected condition between the wireless communication unit and the service center, or performed at a time after connecting the communication line between the wireless communication unit and the service center under a circumstance that the communication line is disconnected between the wireless communication unit and the service center; and
a speed sensor that detects a speed of the vehicle,
wherein the control unit connects the communication line between the wireless communication unit and the service center when a first condition and a second condition are fulfilled,
the first condition is that the speed of the vehicle detected by the speed sensor is smaller than a predetermined value, and
the second condition is that the communication line between the wireless communication unit and the service center is being disconnected.

2. The vehicle navigation apparatus as in claim 1,
wherein the user operation by the user on an operation switch and/or an operation remote controller is not accepted by the control unit when the vehicle is traveling, and
the user operation by the user on an operation switch and/or an operation remote controller is accepted by the control unit when the vehicle is stopping.

3. The vehicle navigation apparatus as in claim 1,
wherein the control unit connects the communication line between the wireless communication unit and the service center when an additional condition is fulfilled, and
the additional condition includes a brake signal for applying a brake to the vehicle.
